(19) United States
(12) Patent Application Publication
(10) Pub. No.: US 2004/0192411 A1
(43) Pub. Date: Sep. 30, 2004

(54) Conservation of power in radiotelephone use

(75) Inventor: Jae H. Shim, San Jose, CA (US)

Correspondence Address: JAE SHIM, 5944 KILLARNEY CIRCLE, SAN JOSE, CA, 95138, US

(73) Assignee: MOBIGENCE, INC

(21) Appl. No.: 09/737,419

(22) Filed: Dec. 14, 2000

(51) Int. Cl. H04B 1/38

(52) U.S. Cl. 455/574; 455/343.1

(57) ABSTRACT

Method and system for conserving power used by a radiotelephone backlight. When at least one of a selected group of radiotelephone functions is presently in use and the ambient light intensity ALI at the radiotelephone is less than a reference value ALI(ref), the backlight is powered to a selected power level for a selected timeout interval. Where the ALI value is at least equal to the ALI(ref) value, or where none of the selected functions is presently in use, at the end of the timeout interval, power for the backlight is withdrawn. The ALI(ref) value and/or the selected backlight power level are optionally adjustable according to at least one of a difference, ALI(ref)−ALI, and a ratio ALI/ALI(ref). The ALI(ref) value and/or selected backlight power level are optionally adjustable for an individual user's requirements.

### FIELD OF THE INVENTION

This invention relates to conserving battery power on backlight in a portable hand-held radiotelephone.

### BACKGROUND OF THE INVENTION

A conventional portable handheld radiotelephone (referred to as a “radiotelephone” herein) provides backlight, which may be generated by one or more light emitting diodes (referred to as “LEDs” herein), electro-luminescence (referred to as “EL” herein), or other light emitting electrical to sources, illuminates a viewable area such as a liquid crystal display (referred to as a “LCD” herein) and a keypad. A user is still able to view the LCD and access the keypad without the aid of external light sources, even if the surrounding area is dark.

Among the electrical components in a conventional radiotelephone, the backlight consumes a major portion of the power. In order to reduce the battery power associated with backlight use, a radiotelephone often adapts a timer based backlight turn-on/turn-off control: the user has an option to choose one of the pre-determined timer settings provided as a feature with the radiotelephone so that, upon each key press, the backlight is turned on for a pre-determined time interval. However, this use of timer based backlight control does not adequately account for variation of the ambient light. The backlight with turn-on, which helps viewing and/or accessing the LCD and keypad more clearly when the ambient light is insufficient, but does not improve viewing and accessing when the ambient light is sufficient to permit viewing and accessing without use of another light source. The additional illumination provided by the backlight is often unnoticeable by the user during the day time, resulting in unnecessary and non-beneficial use of the battery power. Presently available technology provides an option to choose to turn off the backlight in selected circumstances, resulting in a saving of battery power. However, this technology is often inconvenient and/or cumbersome for the user because it requires changing the settings repeatedly as the circumstances change.

What is needed is an approach that provides the backlight automatically, without changing its settings but only when it is needed, so that the corresponding battery power during the backlight turn-on can be further saved while it is not needed.

### SUMMARY OF THE INVENTION

It is a principal object of the present invention to save the battery power associated with the backlight by placing one of more types of light sensors in strategically selected locations in the radiotelephone. One or more light sensors can be located near by where the LCD and keypad are located at such that it can measure the amount of intensity of the surrounding light. Depending on the threshold setting in terms of its brightness or darkness, which can be pre-programmable by the user and/or the settings provided by the radiotelephone, the backlight can be automatically turned on and off without the user's intervention.

Further, backlight operation can provide relatively more battery power saving by pre-programming the backlight brightness with multiple settings, that correspond to the intensity of surrounding light. This configuration provides more optimized viewing and/or accessing of LCD and/or keypad with respect to brightness of the backlight while conserving more battery power without comprising other performance.

### BRIEF DESCRIPTION OF THE DRAWINGS

FIG. 1 is a schematic view of a radiotelephone configured to practice the invention.

FIG. 2 is a flow chart of a procedure for practicing the invention.

FIGS. 3 and 4 illustrate graphically possible variations of backlight power supplied with certain ambient light intensities.

### DETAILED DESCRIPTION OF THE PREFERRED EMBODIMENTS

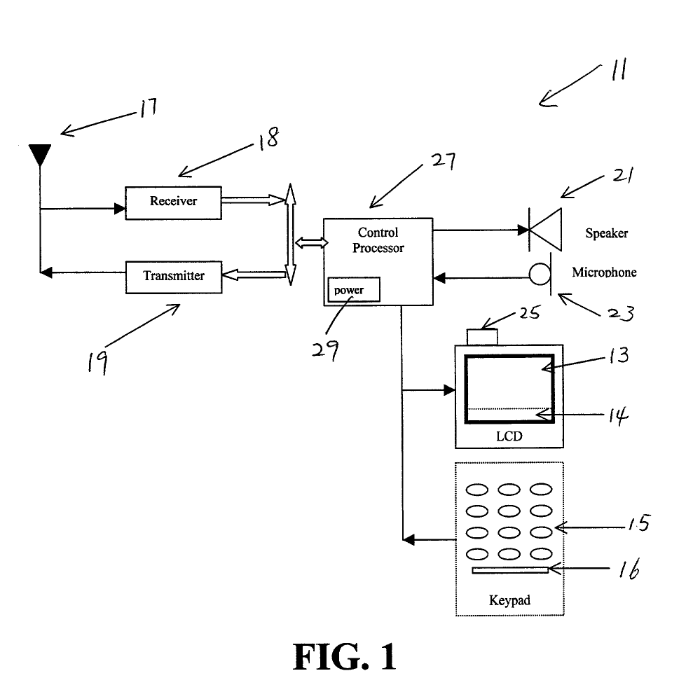

FIG. 1 is a perspective view of a radiotelephone 11 configured to practice the invention in one embodiment. A front side and/or a back side of the radiotelephone 11 includes LCD(s) 13, an LCD backlight 14, a keypad 15, a keypad backlight 16, an antenna 17, a speaker 21, a microphone 23, an ambient light intensity (ALI) sensor 25, a controller 27, including a microprocessor or computer, that receives and analyzes the sensed ALI, and an electrical power source 29 with a controllable load, connected to one or more of the backlights. In response to receipt of an ALI value from the sensor 25 and comparison of this ALI value with a reference value ALI(ref), the controller 27 adjusts the electrical power provided by the power source 29 for the backlight(s) 14 and/or 16. This power adjustment may be full-off or full-on or may vary monotonically with the difference, ALI(ref)−ALI, or with the ratio, ALI/ALI(ref), using a present or recent-past ALI value. The reference value ALI(ref) may be varied by the user to accommodate the eye sensitivity or visual acuity of the user.

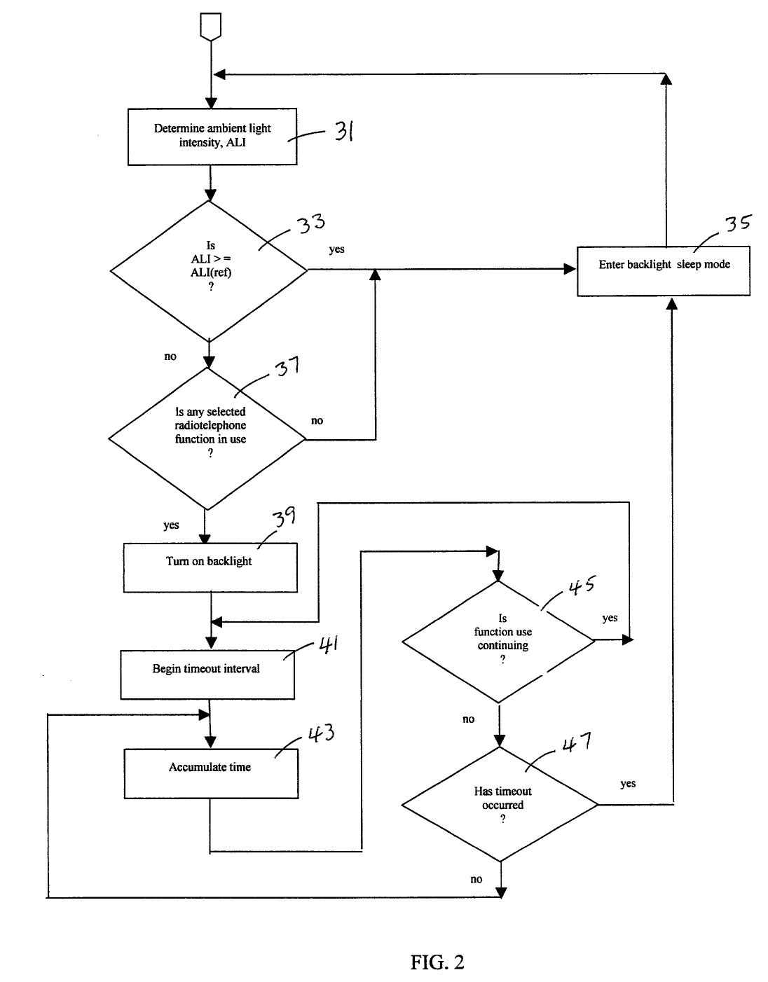

FIG. 2 is a flow chart of a procedure for practicing the invention. In step 31, the system measures or receives ambient light intensity (ALI) for the radiotelephone. In step 33, the system determines if the ALI is at least as large as a reference value ALI(ref). If the answer to the query in step 33 is “yes,” the system enters, or continues to reside in, a backlight sleep mode, in step 35, and returns to step 31. If the answer to the query in step 33 is “no,” the system determines if one or more of a selected group of radiotelephone functions is in use, in step 37. If the answer to the query in step 37 is “no,” the system enters, or continues to reside in, the backlight sleep mode, in step 35, and returns to step 31. If the answer to the query in step 37 is “yes,” the system turns on the backlight, using power up to a selected level, in step 39.

In step 41, the system initiates a timeout interval, in step 41, and begins accumulating time, in step 43. In step 45, the system determines if at least one of the selected group of radiotelephone functions continues to be used. If the answer to the query in step 45 is “yes,” the system returns to step 41 and initiates a new timeout interval. If the answer to the query in step 45 is “no,” the system determines if timeout has occurred (i.e., if the timeout interval has ended), in step 47. If the answer to the query in step 47 is “no,” the system returns to step 43 and continues to accumulate time. If the answer to the query in step 47 is “yes,” the system enters the backlight sleep mode, in step 35, and returns to step 31.

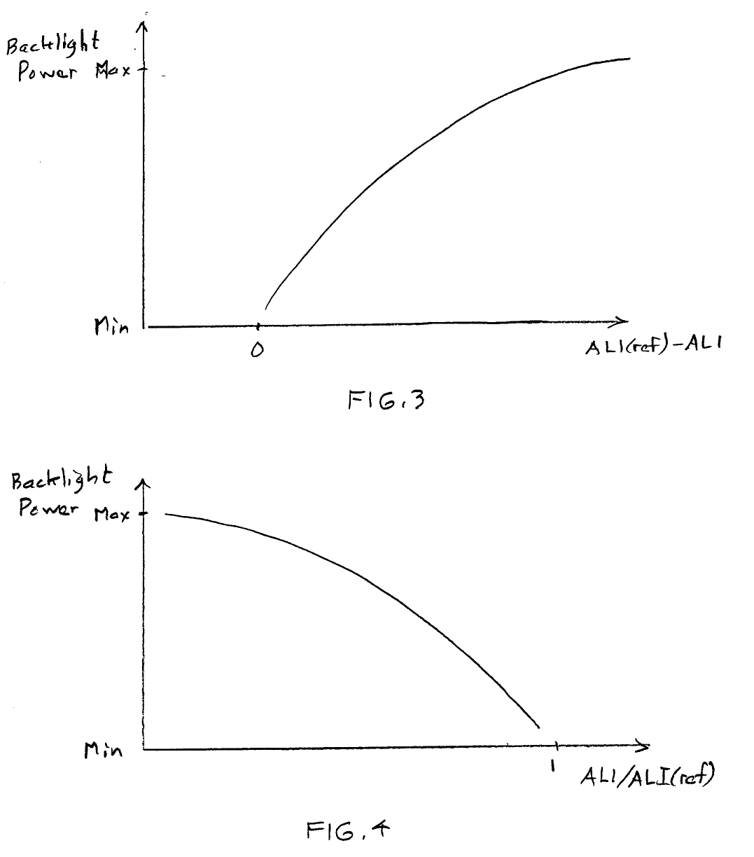

The selected level of backlight power provided by the system in step 39 may be an absolute value of power, such as fully-on. Alternatively, the selected level of backlight power provided may vary monotonically with one or more of the variables v1=ALI(ref)−ALI and v2=ALI/ALI(ref). For example, as the variable v1 decreases through positive values toward 0, illustrated in FIG. 3, the ambient light intensity ALI is increasing toward the value, ALI(ref), at which point the backlight is not needed for adequate illumination and/or display of alphanumeric and/or graphical information on a radiotelephone display screen. As the variable v2 increases from 0 to 1, illustrated in FIG. 4, the ambient light intensity ALI is (again) increasing toward the value ALI(ref). As v1 decreases through positive values toward 0, and/or as v2 increases toward 1, the power provided for the backlight can be decreased monotonically, if not strictly monotonically, toward zero power.

Different radiotelephone users will have different eye sensitivities and/or visual acuities and may require different amounts of backlight to provide adequate illumination. The system allows a user to adjust the reference value ALI(ref), a selected power level provided for the backlight and other parameters according to the user's own requirements. Optionally, a radiotelephone may store the values of these adjustable parameters for one or more regular users of that radiotelephone so that, by entering a specialized keystroke sequence (e.g., a password) unique to that user, these parameters are automatically adjusted to their optimal values for that user. A set of one or more default parameters is optionally stored in the radiotelephone for users who have no special vision characteristics or requirements.

What is claimed is:

1. A method for conserving power in operation of a radiotelephone, the method comprising:
determining an ambient light intensity, referred to as an “ALI”, at a radiotelephone;
comparing the ALI value with a reference value ALI(ref);
when the ALI value is at least as large as the ALI(ref) value, causing a backlight associated with the radiotelephone to enter a sleep mode;
when the ALI value is less than the ALI(ref) value:
determining if at least one function in a selected group of radiotelephone functions is presently in use;
when no function from the selected group is presently in use, causing the backlight to enter the sleep mode;
when at least one function from the selected group is presently in use, turning on the backlight to a selected energy level and beginning to accumulate time under a selected timeout interval;
determining if at least one function from the selected group is still presently in use;
when at least one function from the selected group is still presently in use, resetting the beginning of the timeout interval;
when no function from the selected group is presently in use, continuing to accumulate time under the timeout interval, and determining if the timeout interval is completed; and
when the timeout interval is completed, causing the backlight to enter the sleep mode.

2. The method of claim 1, further comprising choosing said selected backlight energy level to be a monotonically decreasing function of an intensity difference, ALI(ref)−ALI, when said ALI value is less than said reference value ALI(ref).

3. The method of claim 1, further comprising choosing said selected backlight energy level to be a monotonically decreasing function of an intensity ratio, ALI/ALI(ref), when said ALI value is less than said reference value ALI(ref).

4. The method of claim 1, further comprising providing an adjustment to a user-specified value of at least one of said reference value ALI(ref) and a selected power level provided for said backlight.

5. The method of claim 4, further comprising:
storing said user-specified value; and
providing said adjustment to said user-specified value of said at least one of said reference value ALI(ref) and said selected power level provided for said backlight, upon receipt of a keystroke sequence that identifies said user.

6. The method of claim 4, further comprising providing a selected default value for said at least one of said reference value ALI(ref) and said selected power level provided for said backlight.

7. A system for conserving power in operation of a radiotelephone, the system comprising:
a light sensor that determines an ambient light intensity, referred to as an “ALI”, at a radiotelephone; and
a computer that is programmed:
to compare the ALI value with a reference value ALI(ref);
when the ALI value is at least as large as the ALI(ref) value, to cause a backlight associated with the radiotelephone to enter a sleep mode;
when the ALI value is less than the ALI(ref) value:
to determine if at least one function in a selected group of radiotelephone functions is presently in use;
when no function from the selected group is presently in use, to cause the backlight to enter the sleep mode;
when at least one function from the selected group is presently in use, to turn on the backlight to a selected energy level and to begin to accumulate time under a selected timeout interval;
to determine if at least one function from the selected group is still presently in use;
when at least one function from the selected group is still presently in use, to reset the beginning of the timeout interval;
when no function from the selected group is presently in use, to continue to accumulate time under the timeout interval, and to determine if the timeout interval is completed; and
when the timeout interval is completed, to cause the backlight to enter the sleep mode.

8. The system of claim 7, wherein said computer is further programmed to choose said selected backlight energy level to be a monotonically decreasing function of an intensity difference, ALI(ref)−ALI, when said ALI value is less than said reference value ALI(ref).

9. The system of claim 7, further wherein said computer is further programmed to choose said selected backlight energy level to be a monotonically decreasing function of an intensity ratio, ALI/ALI(ref), when said ALI value is less than said reference value ALI(ref).

10. The system of claim 7, wherein said computer is further programmed to provide an adjustment to a user-specified value of at least one of said reference value ALI(ref) and a selected power level provided for said backlight.

11. The system of claim 10, wherein said computer is further programmed:
to store said user-specified value; and
to provide said adjustment to said user-specified value of said at least one of said reference value ALI(ref) and said selected power level provided for said backlight, upon receipt of a keystroke sequence that identifies said user.

12. The system of claim 10, wherein said computer is further programmed to provide a selected default value for said at least one of said reference value ALI(ref) and said selected power level provided for said backlight.

13. A method for conserving power in operation of a radiotelephone, the method comprising:
determining an ambient light intensity, referred to as an “ALI”, at a radiotelephone and comparing the ALI value with a reference value ALI(ref);
causing a backlight associated with the radiotelephone to enter a sleep mode when at least one of the following two conditions is present: (i) the ALI value is at least as large as the ALI(ref) value and (ii) no function from a selected group of radiotelephone functions is activated within a selected timeout interval having a selected timeout length; and
when at least one function from the selected group is presently activated, turning on the backlight to a selected energy level, beginning to accumulate time, and comparing the accumulated time with the timeout value.

14. The method of claim 13, further comprising choosing said selected backlight energy level to be a monotonically decreasing function of an intensity difference, ALI(ref)−ALI, when said ALI value is less than said reference value ALI(ref).

15. The method of claim 13, further comprising choosing said selected backlight energy level to be a monotonically decreasing function of an intensity ratio, ALI/ALI(ref), when said ALI value is less than said reference value ALI( ref).

16. The method of claim 13, further comprising providing an adjustment to a user-specified value of at least one of said reference value ALI(ref) and a selected power level provided for said backlight.

17. The method of claim 15, further comprising:
storing said user-specified value; and
providing said adjustment to said user-specified value of said at least one of said reference value ALI(ref) and said selected power level provided for said backlight, upon receipt of a keystroke sequence that identifies said user.

18. The method of claim 16, further comprising providing a selected default value for said at least one of said reference value ALI(ref) and said selected power level provided for said backlight.
